(19) United States
(12) Patent Application Publication
(10) Pub. No.: US 2004/0000858 A1
(43) Pub. Date: Jan. 1, 2004

(54) Deflection yoke

(75) Inventors: Seok Hwan Hwang, Suwon-Shi (KR); Jeom Soo Cho, Suwon-Shi (KR); Chul Ho Jeong, Suwon-Shi (KR); Young Hoon Cho, Suwon-Shi (KR); Deok Ho Ha, Suwon-Shi (KR); Jae Jung Kim, Suwon-Shi (KR)

Correspondence Address: DARBY & DARBY P.C., 805 Third Avenue, New York, NY, 10022, US

(73) Assignee: SAMSUNG ELECTRO MECHANICS CO., LTD.

(21) Appl. No.: 10/313,680

(22) Filed: Dec. 6, 2002

(30) Foreign Application Priority Data
Jun. 28, 2002 (KR) 2002-36554
Nov. 25, 2002 (KR) 2002-73550

(51) Int. Cl. H01J 29/70

(52) U.S. Cl. 313/440

(57) ABSTRACT

A deflection yoke attached to a cathode ray tube to deflect an electron beam generated from an electron gun includes a coil separator having a horn shape and electrically insulating deflection coils, a horizontal deflection coil having a pair of upper and lower coils disposed on an inside of the coil separator to generate a horizontal deflection magnetic field to deflect the electron beam in a horizontal direction, a vertical deflection coil having a pair of right and left coils disposed on an outside of the coil separator to generate a vertical deflection magnetic field, having a deflection coil portion and a bent coil portion extended from the deflection coil portion to generate a magnetic field, which is in an opposite direction to another magnetic field generated from a portion of the deflection coil portion disposed adjacent to the bent coil portion and weakens another magnetic field generated from the deflection coil portion, and having a vertical radius and a horizontal radius, which is different from the vertical radius, and a ferrite core having a cylindrical shape covering a portion of the deflection coil portion of the vertical deflection coil to strengthen the vertical deflection magnetic field and the horizontal deflection magnetic field. A magnetic field generated from a corner portion of the vertical deflection coil is weakened to correct the pincushion distortion of the screen as well as the misconvergence.

### CROSS-REFERENCE TO RELATED APPLICATION

This application claims to benefit of Korean Patent Application No. 2002-36554, filed Jun. 28, 2002, in the Korean Intellectual Property Office, the disclosure of which is incorporated herein by reference.

### BACKGROUND OF THE INVENTION

1. Field of the Invention

The present invention relates to a deflection yoke, and more particularly, to a deflection yoke compensating for a screen distortion.

2. Description of the Related Art

Generally, a deflection yoke is one of various types, such as a saddle toroidal type, a saddle and saddle type, etc., according to a deflection coil used in a cathode ray tube (CRT) in a monitor or a television.

For example, a winding coil formed in a certain shape is called the saddle and saddle type (winding frame type) deflection coil, a winding coil formed on a cylindrical shaped-ferrite core of a magnetic material is called the saddle toroidal type deflection yoke, and a winding coil formed on a cylindrical bobbin is called a bobbin type deflection yoke.

FIGS. 1 through 3 shows a conventional deflection yoke 1 adopting one of the above deflection coils. FIG. 1 is a partial cross-sectional view showing the conventional deflection yoke adopting the deflection coil, FIG. 2 is a cross-sectional view of the conventional deflection yoke, and FIG. 3 is cross-sectional view taken along A-A′ of FIG. 2.

As shown in FIGS. 1 through 3, the deflection yoke 1 is symmetrical and is provided with a coil separator 10 having a pair of portions formed in an integrated body.

The coil separators 10 includes a screen portion 11 having a screen plate 2a of the CRT, a rear cover 12 formed to be extended from the screen portion 11, and a neck portion extended from a central portion of the rear cover 12 to be coupled to an electron gun of the CRT.

On an inside and an outside of the coil separator 10A are provided a horizontal deflection coil 20 having a pair of upper and lower portions generating a horizontal magnetic field to deflect en electron beam in a horizontal direction and a vertical deflection coil 30 having a pair of left and right portions generating a vertical magnetic field to deflect the electron beam in a vertical direction, respectively. The horizontal deflection coil 20 and the vertical deflection coil 30 are collectively called a deflection coil.

A ferrite core 40 having a cylindrical shape and made of a magnetic material is provided on an outside of the vertical deflection coil 30 to strengthen the horizontal magnetic field and the vertical magnetic field. The ferrite core 40 is mounted to cover the vertical deflection coil 30 except for front and rear portions of the vertical deflection coil 30. As shown in FIG. 2, the ferrite core 40 covers a middle portion of the vertical deflection coil 30.

The horizontal deflection coil 20 and the vertical deflection coil 30 are provided with bent coil portions 22, 32 each having an outward flange shape, and neck bent portions 24, 34 in the front and rear portions thereof, respectively.

The bent coil portions 24, 34 may not have the outward flange shape but have other shapes. The deflection coil, which does not have the outward flange shape, is called an unbent type deflection coil.

The conventional deflection yoke 1 is explained in detail in conjunction with FIG. 3. On upper and lower surface of the inside of the coil separator 10 are provided the pair of the upper and lower portions of the horizontal deflection coil 20, respectively. On left and right side surfaces of the outside of the coil separator 10 are provided the pair of left and right portions of the vertical deflection coil 30, respectively. The ferrite core 40 is disposed on an outside surface of the vertical deflection coil 30.

The conventional deflection yoke 1 is provided with the horizontal deflection coil 20, the coil separator 10, the vertical deflection coil 30, and the ferrite core 40 which are sequentially formed.

FIGS. 4 through 6 show a structure of the vertical and horizontal deflection coils 20, 30 generating vertical and horizontal deflection magnetic fields VB, HB, respectively, and respective deflection forces in detail. FIG. 4 is a front view of the vertical deflection coil 30 of the conventional deflection yoke 1 shown in FIG. 2, FIG. 5 is a diagram showing a downward vertical deflection force F of the vertical deflection magnetic field VB in the vertical deflection coil 30 shown in FIG. 4, and FIG. 6 is another diagram showing a relationship between the downward vertical deflection force F and an electron beam in the vertical deflection coil 30 shown in FIG. 5.

The vertical deflection coil 30 as the deflection coil is described in FIGS. 4 and 5. Since a structure and a function of the horizontal deflection coil 20 are the same as the vertical deflection coil 30, descriptions explaining the structure and the function of the horizontal deflection coil 20 are omitted.

As shown in FIG. 4, the bent coil portion 32 of the vertical deflection coil 30 used in the conventional deflection yoke 1 includes a non-effective bent portion 33 generating an unnecessary magnetic field affecting the vertical deflection force F of the electron beam in the vertical magnetic deflection field VB of the vertical deflection coil 30. The non-effective bent portion 33 is extended to upper and lower corner portions of the vertical deflection coil 30.

A deflection coil portion 35 is extended from the bent coil portion 32 to generate the vertical deflection magnetic field VB and the vertical deflection force F in a vertical direction, and first, second, third, and fourth deflection coil portions 35a, 35b, 35c, 35d are formed in the deflection coil portion 35 in order in a direction from a vertical center line of the deflection yoke 1 to one of a left side and a right side of the deflection yoke 1.

The first, second, third, and fourth deflection coil portions 35a, 35b, 35c, 35d are extended to the rear portion of the vertical deflection coil 30 to form the neck bent portion 34 in a body and are disposed between the bent coil portion 32 and the neck bent portion 34.

The respective numbers (turn ratios) of windings of the first, second, third, and fourth deflection coil portions 35a, 35b, 35c, 35d decrease in a direction from the first deflection coil 35a to the fourth deflection coil 35d, that is, from the vertical center line to the one of the left side and the right side of the deflection yoke 1, to decrease the vertical deflection force F in the direction from the first deflection coil 35a to the fourth deflection coil 35d.

For example, the turn ratios of the first deflection coil 35a to the fourth deflection coil 35d are expressed as 15:9:7:3. If the number of the windings of the fourth deflection coil portion 35d is greater than that of one of the first, second, third deflection coil portions 35a, 35b, 35c, an area of a magnetic field generated from the fourth deflection portion 35d is strengthened and then becomes stronger than other areas of the vertical deflection magnetic field VB generated from the first through third deflection coil portions 35a, 35b, 35c to longitudinally deflect the electron beam toward the fourth deflection coil portion 35d other than the vertical direction.

If the electron beam is longitudinally deflected toward the fourth deflection coil portion 35d, that is, upper or lower corner portion of the vertical deflection coil 30, which is disposed adjacent to the bent coil portion 32, a distortion of a pincushion phenomenon occurs on a screen of the screen plate 2a since the electron beam is scanned toward a corner of the screen of the screen plate 2a. As a result, it is impossible to display a normal screen on the screen plate 32a.

Accordingly, in order to avoid the pincushion phenomenon, the number of the windings of the fourth deflection coil portion 35d may be adjusted to be less than that of the first through third deflection coil portions 35a, 35b, 35c.

However, there is a physical limitation on a design of the deflection yoke 1 minimizing the number of the windings of the fourth deflection coil portion 35d. Even if the number of the windings of the fourth deflection coil portion 35d is reduced to an allowable minimum number, the electron beam is deflected toward the corner of the screen due to the magnetic field generated from the fourth deflection coil portion 35d, and the distortion of the pincushion phenomenon still occurs on the screen of the screen plate 2a.

That is, it is impossible to prevent the electron beam from being longitudinally deflected toward the corner of the screen only by adjusting the number of the windings of the fourth deflection coil portion 35d.

As shown in FIG. 5, the deflection coil 30 generates the vertical deflection force F in the vertical deflection magnetic field VB, and the vertical deflection force F of FIG. 5 represents a downward force vertically deflecting the electron beam.

In FIG. 5, when the vertical deflection force F is the downward force deflecting the electron beam in a vertically downward direction, a current I flows from an upper portion of the left or right portion of the deflection coil portion 35 to a lower portion of the left or right portion of the deflection coil portion 35 through the bent coil portion 32. The vertical deflection magnetic field VB is generated according to the Fleming's rule (right screw law) on a direction of the current I.

In accordance with the vertical deflection magnetic field VB formed by the deflection coil portion 35 of the vertical deflection coil 30 to deflect the electron beam in the vertical direction, the vertical deflection force F is generated in the downward direction by the vertical deflection magnetic field VB.

The vertical deflection force F is generated in the downward direction from the vertical deflection magnetic field VB and the direction of the current I according to the Fleming's rule (left hand law).

The unnecessary magnetic field generated from the bent coil portion 32 may not affect the vertical deflection force F since a magnetic force of the unnecessary magnetic field is insignificant.

As shown in FIG. 6, the vertical deflection magnetic field VB formed by the vertical deflection coil 30 of the conventional deflection yoke 1 is represented by a barrel shaped magnetic field in which a magnetic field of both side areas (left and right corner areas) of the vertical deflection magnetic field VB is stronger than that of a center area of the vertical deflection magnetic field VB. The barrel shaped magnetic field shows that a strength of the magnetic field of the center area of the vertical deflection magnetic field VB is represented by “convex,” and the strength of he magnetic field of the side areas of the vertical deflection magnetic field VB is represented by “concave” with respect to a horizontal center line of the vertical deflection coil 30.

As a result, the center area of the vertical deflection magnetic field VB is distributed to be distance from the electron beam, and the side areas (left and right corner areas) of the vertical deflection magnetic field VB is distributed to be close to the electron beam. R, G, and B electron beams are collectively called as the electron beam.

Accordingly, the electron beam is strongly deflected (biased) to be longitudinally extended toward the both side areas of the vertical deflection magnetic field VB rather than the center area of the vertical deflection magnetic field VB.

Due to the magnetic field of the fourth deflection coil 35d, the magnetic field of the both side areas of the vertical deflection magnetic field VB is formed to be stronger than the center area of the vertical deflection magnetic field VB.

The horizontal deflection magnetic field HB is a deflection magnetic field which deflects the electron beam in a left or right direction of the screen displayed on the screen plate 2a and is generated by the horizontal deflection coil 20.

In the horizontal deflection magnetic field HB, a center area is represented by “concave,” and both side areas (upper and lower corner areas) are represented by “convex.” That is, the center area of the horizontal deflection magnetic field HB is weaker than the side areas of the horizontal deflection magnetic field HB. Although the center area of the horizontal deflection magnetic field HB is distributed to be closed to the electron beam, the electron beam is longitudinally deflected toward the corner area of the screen due to the side areas of the horizontal deflection magnetic field HB.

That is, since a magnetic difference between the center area of the horizontal deflection magnetic field HB and the both side areas of the horizontal deflection magnetic field HB is insignificant, the electron beam is not deflected to a leftmost or rightmost side of the screen but longitudinally deflected toward the corner of the screen.

FIGS. 7 and 8 shows the vertical deflection force F is an upward deflection force generated by the vertical deflection coil 30. FIG. 7 is another diagram showing the upward deflection force of the vertical deflection magnetic field VB in the vertical deflection coil 30 shown in FIG. 4, and FIG. 8 is another diagram showing a relationship between the upward deflection force and the electron beam in the vertical deflection coil 30 shown in FIG. 7.

In FIG. 7, the current I flows in a reversed direction opposite to the direction of FIG. 5 to generate the upward deflection force due to the vertical deflection magnetic field VB formed in an opposite direction of FIG. 6.

Accordingly, the vertical deflection force F, which is the upward deflection force, is generated due to the current I and the vertical deflection magnetic field VB, and the electron beam is deflected in an upward direction due to the vertical deflection force F.

As shown in FIG. 8, the strength of the vertical deflection magnetic field VB formed by the vertical deflection coil 30 is represented by the barrel shaped magnetic field in which both side areas of the vertical deflection magnetic field VB are concave,” and the center area of the vertical deflection magnetic field VB is “convex” with respect to the horizontal center line of the vertical deflection coil 30, and the electron beam is deflected toward the corner of the screen rather than uppermost or lowermost side of the screen of the screen plate 2a. As a result, the distortion of the pincushion phenomenon occurs in the screen.

The distortion of the pincushion phenomenon is explained in conjunction with FIGS. 9 and 10 in detail. FIG. 9 is another diagram showing a process of scanning the electron beam on the screen plate 2a of the cathode ray tube shown in FIG. 1, and FIG. 10 is another diagram showing a screen distortion caused by the conventional deflection yoke 1 in the cathode ray tube shown in FIG. 1.

FIG. 9 shows a plan view of the screen plate 2a, which is described as a straight line. The R, G, B electron beams are focused on a dotted line representing a rounded surface of the screen plate 2a. However, if the screen plate 2a is a flat surface (a solid line), the R, G, B electron beams pass through the dotted line, intersect each other, and are longitudinally deflected toward the corner or the sides of the screen of the screen plate 2a.

The R, G, B electron beams are not only longitudinally deflected toward the corner or the sides of the screen but generate a misconvergence in which the R, G, B electron beams are not converged in a dot with respect to the G electron beam.

When the R, G, B electron beams are longitudinally deflected toward the corner or the sides of the screen of the screen plate 2a, a geometrical distortion of the pincushion phenomenon occurs as shown in FIG. 10. For example, a left and right E-W distortion and an upper and lower N-S distortion occur due to the horizontal deflection magnetic field HB and the vertical deflection magnetic field VB, respectively.

Although this image distortion phenomenon, in which the electron beam is deflected toward the corner or the sides of the screen, may occur due to the flat surface of the screen of the screen plate 2a, the image distortion phenomenon may occur due to the magnetic field generated from the fourth deflection coil 35d formed in the deflection coil portion 35 of the vertical deflection coil 30.

That is, due to the magnetic field of the fourth deflection coil 35d, the vertical deflection magnetic filed VB having the center area concave and the side areas convex longitudinally deflects the electron beam toward the corer or sides of the screen of the screen plate 2a.

As a result, an image screen has corners protruding from a normal position and center areas formed with a pincushion curve.

In order to compensate for the distortion of the pincushion phenomenon, a permanent magnet or a magnetic material (not shown) may be attached to the screen plate 2a of the coil separator 10 of the deflection yoke 1 to strengthen (correct) the barrel shaped magnetic field or a pin magnetic field.

In a case that the center area of the vertical deflection magnetic field VB is weaker than the side areas of the vertical deflection magnetic field VB in the vertical deflection coil 30, the permanent magnet or the magnetic material is attached to the screen plate 2a to strengthen the center area of the vertical deflection magnetic field VB to deflect the electron beam to the uppermost and lowermost areas of the screen.

In a case of the horizontal deflection coil 20, the center area of the horizontal deflection magnetic field HB is strengthened by attaching the permanent magnet or the magnetic material to the screen plate 2a, thereby weakening the magnetic field of the side areas of the vertical deflection magnetic field VB compared to the center area of the vertical deflection magnetic field VB.

If the center area of the vertical deflection magnetic field VB is corrected, the electron beam may be deflected to the leftmost or rightmost side of the screen of the screen plate 2a.

Although a certain amount of the pincushion distortion might be compensated using the permanent magnet or the magnetic material, the number of parts and a manufacturing process increases since additional permanent magnets or the magnetic materials need to be prepared and attached to the cathode ray tube.

As described above, in the conventional deflection yoke, since the vertical deflection magnetic field VB generated by the vertical deflection coil 30 is described as the barrel shape in which the center area is convex, the electron beam is longitudinally deflected to be extended toward the corner of the screen, thereby generating the pincushion distortion on the screen.

In addition, the center area of the horizontal deflection magnetic field HB should be generated to be stronger than side areas (upper and lower corner area). However, since the difference between the center area and the side areas (upper and lower corner areas) in the horizontal deflection magnetic field HB is insignificant, the electron beam cannot be deflected to the leftmost and rightmost sides of the screen, thereby generating the pincushion distortion on the screen.

One of the above problems might be solved by adjusting the number of the windings of the fourth deflection coil 35d of the vertical deflection coil 30. However, it is very difficult to form the winding of the fourth deflection coil 35d according to the number of windings.

Moreover, if the permanent magnet or the magnetic material is used to correct the pincushion distortion, the number of the parts increase, the manufacturing process becomes complicated, and a manufacturing cost of the deflection yoke 1 increases.

Furthermore, if the deflection yoke 1 is used in the cathode ray tube having a flat screen plate, the misconvergence occurs since a path of the electron beam to the screen plate 2a is extended.

### SUMMARY OF THE INVENTION

In order solve the above and other problems, it is an object to provide a deflection yoke able to compensate for a misconvergence and a screen distortion.

It is another object to provide a deflection yoke capable of preventing affecting characteristics of an electron beam and a screen in a cathode ray tube.

Additional objects and advantages of the invention will be set forth in part in the description which follows and, in part, will be obvious from the description, or may be learned by practice of the invention.

To achieve an aspect of the present invention, a deflection yoke attached to a cathode ray tube to deflect an electron beam generated from an electron gun includes a coil separator having a horn shape and electrically insulating deflection coils, a horizontal deflection coil having a pair of upper and lower coils disposed on an inside of the coil separator to generate a horizontal deflection magnetic field to deflect the electron beam in a horizontal direction, a vertical deflection coil having a pair of right and left coils disposed on an outside of the coil separator to generate a vertical deflection magnetic field, having a deflection coil portion and a bent coil portion extended from the deflection coil portion to generate a magnetic field, which is in an opposite direction to another magnetic field generated from a portion of the deflection coil portion disposed adjacent to the bent coil portion and weakens another magnetic field generated from the deflection coil portion, and having a vertical radius and a horizontal radius, which is different from the vertical radius, and a ferrite core having a cylindrical shape covering a portion of the deflection coil portion of the vertical deflection coil to strengthen the vertical deflection magnetic field and the horizontal deflection magnetic field.

According to another aspect of the present invention, a ratio of a vertical radius and a horizontal radius of the vertical deflection coil is 1:0.5-0.8.

According to another aspect of the present invention, the bent coil portion disposed adjacent to a screen forms an angle of 15-45 degrees with the deflection coil portion disposed adjacent to the bent coil portion.

According to another aspect of the present invention, the vertical deflection coil is formed on a bobbin.

According to another aspect of the present invention, the vertical deflection coil has a horizontal radius less than that of the ferrite core.

In order to achieve another aspect of the present invention, a deflection yoke attached to a cathode ray tube to deflect an electron beam generated from an electron gun includes a coil separator having a horn shape and electrically insulating deflection coils, a horizontal deflection coil having a pair of upper and lower coils disposed on an inside of the coil separator to generate a horizontal deflection magnetic field to deflect the electron beam in a horizontal direction, having a deflection coil portion and a bent coil portion extended from the deflection coil portion to generate a magnetic field, which is in an opposite direction to another magnetic field generated from a portion of the deflection coil portion disposed adjacent to the bent coil portion and weakens another magnetic field generated from the deflection coil portion, and having a vertical radius and a horizontal radius, which is different from the vertical radius, a vertical deflection coil having a pair of right and left coils disposed on an outside of the coil separator to generate a vertical deflection magnetic field to deflect the electron beam in a vertical direction, and a ferrite core having a cylindrical shape covering a portion of the deflection coil portion of the vertical deflection coil to strengthen the vertical deflection magnetic field and the horizontal deflection magnetic field.

According to another aspect of the present invention, a ratio of a vertical radius and a horizontal radius of the horizontal deflection coil is 1:0.5-0.8.

According to another aspect of the present invention, the bent coil portion disposed adjacent to a screen forms an angle of 15-45 degrees with the deflection coil portion disposed adjacent to the bent coil portion.

According to another aspect of the present invention, the horizontal deflection coil is formed on a bobbin.

### BRIRF DESCRIPTION OF THE DRAWINGS

These and other advantages of the invention will become apparent and more readily appreciated from the following description of the preferred embodiments, taken in conjunction with the accompanying drawings of which:

FIG. 1 is a partial cross-sectional view of the conventional deflection yoke adopting the deflection coil in a cathode ray tube;

FIG. 2 is a cross-sectional view of the conventional deflection yoke shown in FIG. 1;

FIG. 3 is a cross-sectional view taken along A-A′ of FIG. 2;

FIG. 4 is a front view of a vertical deflection coil of the conventional deflection yoke shown in FIG. 2;

FIG. 5 is a diagram showing a downward deflection of a vertical deflection magnetic field in the vertical deflection coil shown in FIG. 4;

FIG. 6 is another diagram showing a relationship between a downward deflection force and en electron beam in the vertical deflection coil shown in FIG. 5;

FIG. 7 is another diagram showing an upward deflection of the vertical deflection magnetic field in the vertical deflection coil shown in FIG. 4;

FIG. 8 is another diagram showing a relationship between an upward deflection force and the electron beam in the deflection coil shown in FIG. 7;

FIG. 9 is another diagram showing a process of scanning the electron beam on a screen plate of the cathode ray tube shown in FIG. 1;

FIG. 10 is another diagram showing a screen distortion caused by the conventional deflection yoke in the cathode ray tube shown in FIG. 1;

FIG. 11 is a partial cross-sectional view showing a deflection yoke in a cathode ray tube according to an embodiment of the present invention;

FIG. 12 is a cross-sectional view of the deflection yoke shown in FIG. 11;

FIG. 13 is a perspective view of a vertical deflection coil shown in FIG. 12;

FIG. 14 is a front view of the vertical deflection coil shown in FIG. 13;

FIG. 15 is a diagram showing a downward deflection force of a vertical deflection magnetic field in the vertical deflection coil shown in FIG. 14;

FIG. 16 is a front view of a horizontal deflection coil shown in FIG. 12;

FIG. 17 is another diagram showing a relationship between a horizontal deflection magnetic field and an electron beam in the horizontal deflection coil shown in FIG. 16;

FIG. 18 is another diagram of a screen plate showing a screen generated by the deflection yoke shown in FIG. 11;

FIG. 19 is an exploded view of a deflection yoke according to another embodiment of the present invention;

FIGS. 20A through 20D show a front view, a rear view, a plain view, and a side view of the deflection yoke shown in FIG. 19, respectively; and

FIG. 21 is a vertical deflection coil of the deflection yoke shown in FIG. 19.

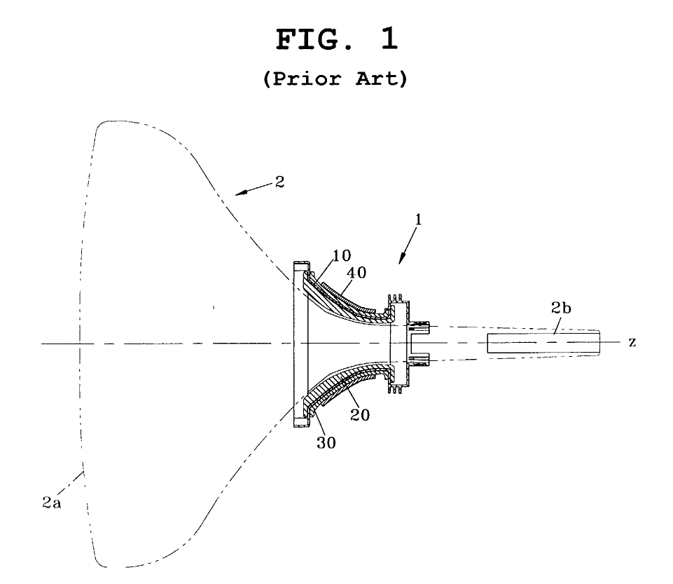

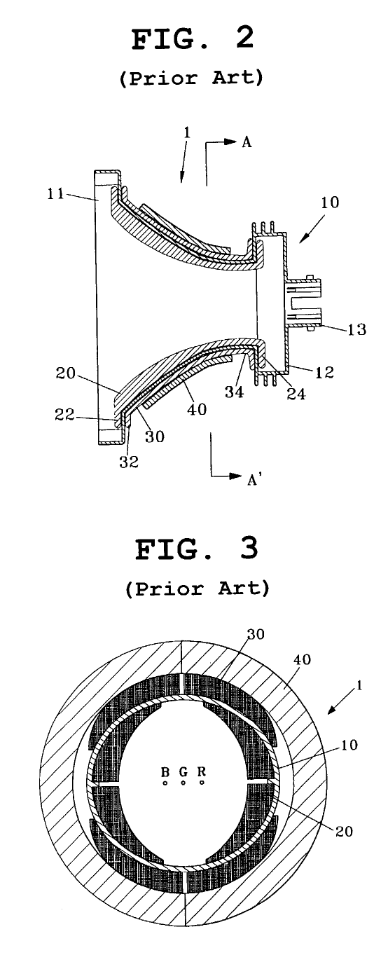

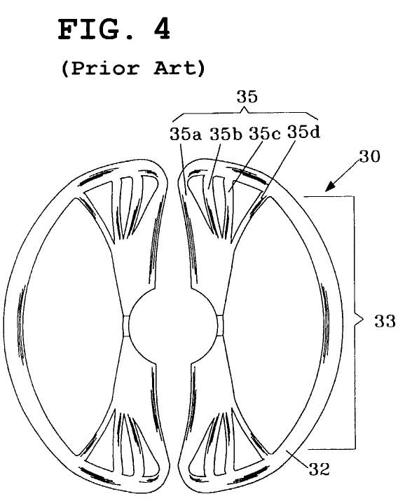

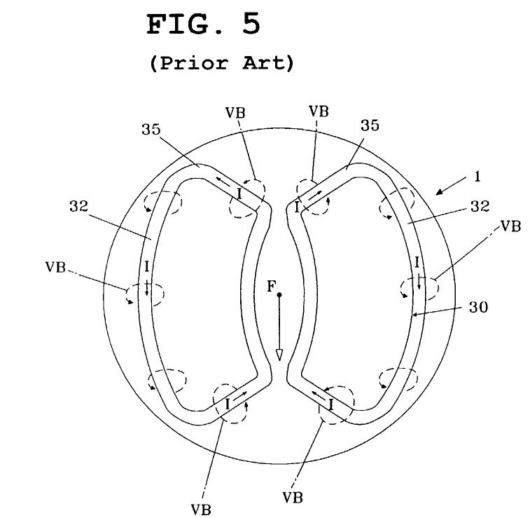

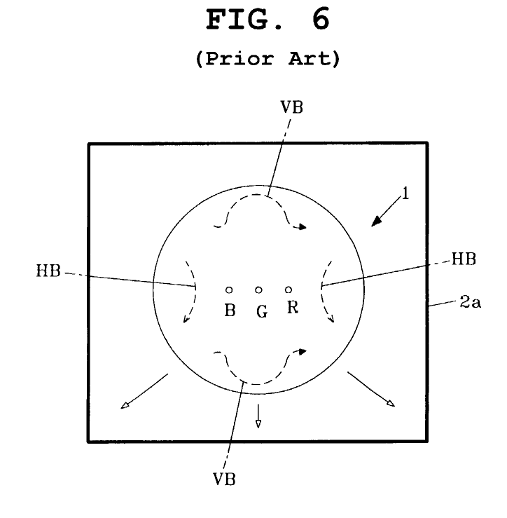

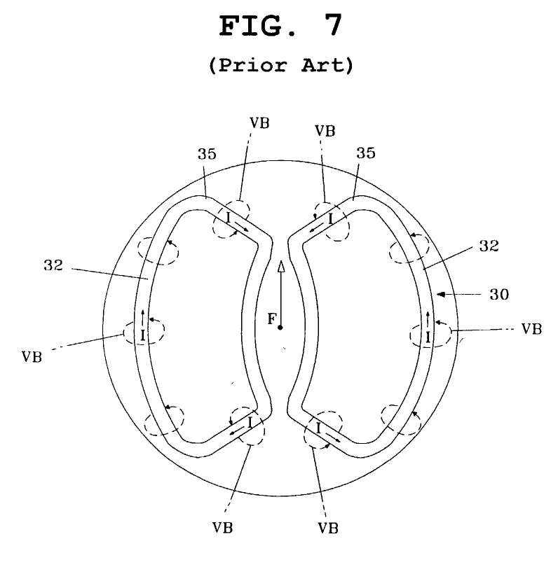

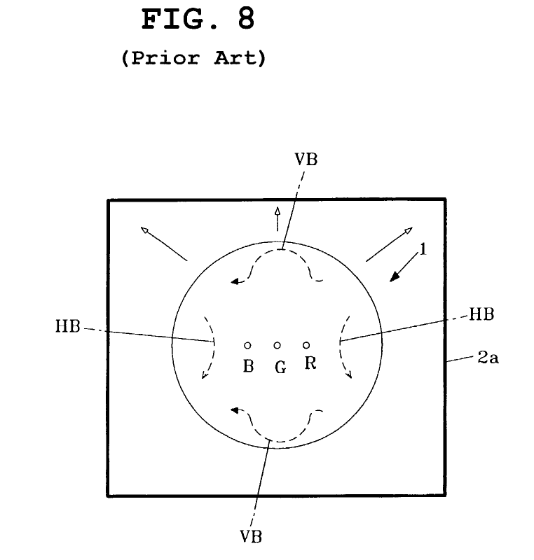

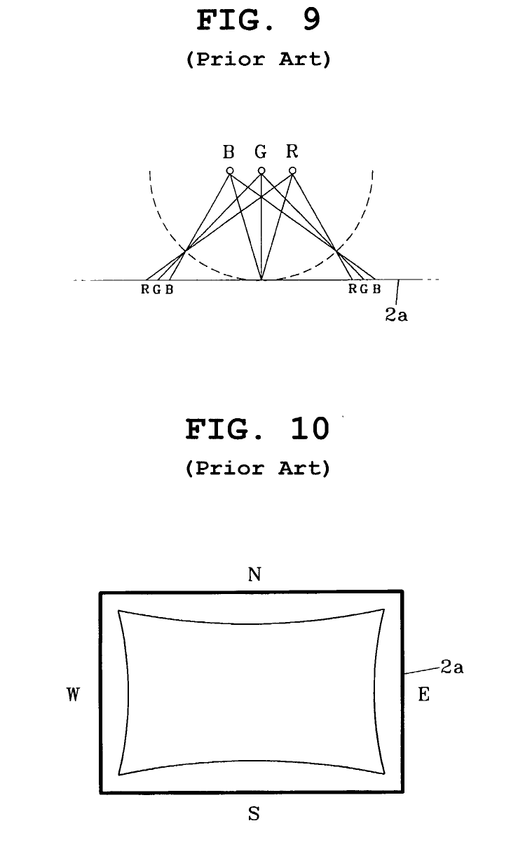

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by reference to the figures.

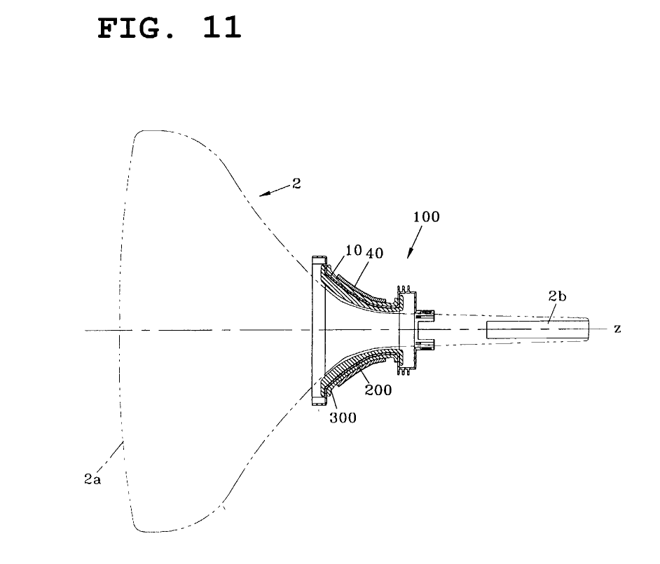

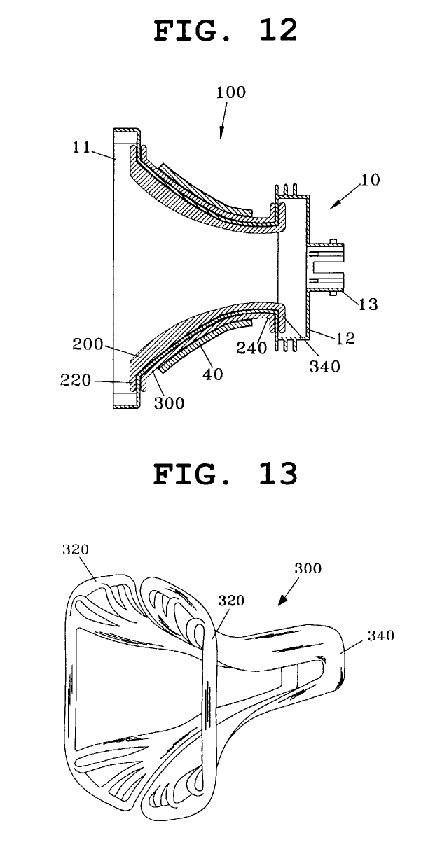

FIG. 11 is a partial cross-sectional view showing a deflection yoke 100 in a cathode ray tube 2 according to an embodiment of the present invention, and FIG. 12 is a cross-sectional view of the deflection yoke 100 shown in FIG. 11.

As shown in FIGS. 11 and 12, the deflection yoke 100 includes a coil separator 10 being symmetrical and having a pair of half portions formed in an integral body.

The coil separators 10 includes a screen portion 11 having a screen plate 2a of the CRT 2, a rear cover 12 formed to be extended from the screen portion 11, and a neck portion 13 extended from a central portion of the rear cover 12 to be coupled to an electron gun of the CRT 2.

On an inside and an outside of the coil separator 10 are provided a horizontal deflection coil 200 having a pair of upper and lower portions generating a horizontal deflection magnetic field to deflect en electron beam in a horizontal direction and a vertical deflection coil 300 having a pair of left and right portions generating a vertical deflection magnetic field to deflect the electron beam in a vertical direction, respectively. The horizontal deflection coil 200 and the vertical deflection coil 300 are collectively called a deflection coil.

A ferrite core 40 having a cylindrical shape and made of a magnetic material is disposed on an outside of the vertical deflection coil 300 to strengthen the horizontal magnetic field and the vertical magnetic field. The ferrite core 40 is mounted to cover the vertical deflection coil 300 except for front and rear portions of the vertical deflection coil 300. As shown in FIG. 12, the ferrite core 40 covers a middle portion of the vertical deflection coil 300.

The horizontal deflection coil 200 and the vertical deflection coil 300 are provided with a bent coil portion 220, 320 having an outward flange shape, and a neck bent portion 240, 340 formed in the front and rear portions thereof, respectively. The bent coil portion 220, 320 and the neck bent portion 240, 340 of the horizontal deflection coil 200 and the vertical deflection coil 300 are formed in an integral body. The bent coil portion 220, 320 is disposed adjacent to the screen plate 2a. The bent coil portion 220, 320 is extended to cross an Z axis of the CRT 2. The Z axis of the CRT 2 is perpendicular to a screen of a screen plate 2a of the CRT 2.

The horizontal deflection 200 and the vertical deflection coil 300 are molded in a winding frame after windings are formed.

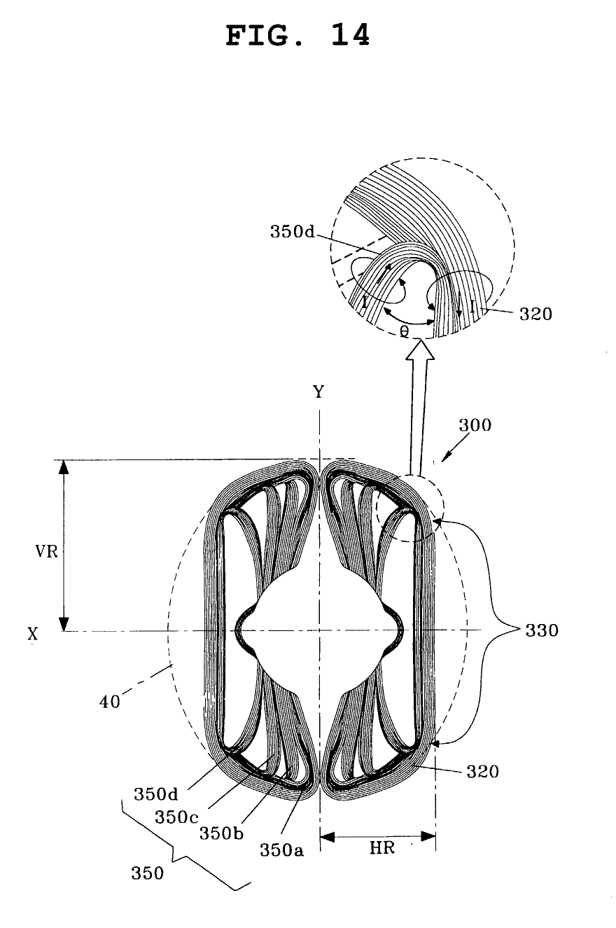

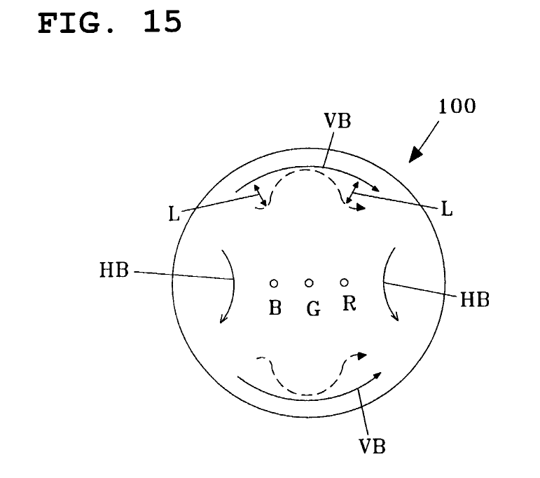

The vertical deflection coil 300 is explained with reference with FIGS. 13 through 15. FIG. 13 is a perspective view of the vertical deflection coil 300 shown in FIG. 12, FIG. 14 is a front view of the vertical deflection coil 300 shown in FIG. 13, and FIG. 15 is a diagram showing a downward deflection force of the vertical deflection magnetic field VB in the vertical deflection coil 300 shown in FIG. 14.

As shown in FIGS. 13 through 15, although the vertical deflection coil 300 of the deflection yoke 100 generates the vertical deflection magnetic field VB to deflect the electron beam in the vertical direction, the bent coil portion 320 generates an unnecessary magnetic field.

In FIG. 14, a non-effective bent portion 330 is formed in the bent coil portion 320 to generate the unnecessary magnetic field, which should not affect the vertical deflection magnetic field VB. The non-effective bent portion 330 is extended from an upper corner portion of the bent coil portion 320 to a lower corner portion of the bent coil portion 320.

A deflection coil portion 350 is extended from the bent coil portion 320 to generate the vertical deflection magnetic field VB, and includes first, second, third, and fourth deflection coils 350a, 350b, 350c, 350d formed in order in a direction from an inside of the vertical deflection coil 300 to the non-effective bent portion 330 of the vertical deflection coil 300.

The numbers of windings (turn ratios) of the first, second, third, and fourth deflection coils 350a, 350b, 350c, 350d may be the same as conventional first, second, third, and fourth deflection coils of a conventional deflection yoke. The number of the windings of the fourth deflection coil 350d is smaller than those of the first, second, and third deflection coils 350a, 350b, 350c.

For example, ratios of the numbers of the windings of the first, second, third, and fourth deflection coils 350a, 350b, 350c, 350d may be 15:9:7:3.

According to an aspect of the present invention, the fourth deflection coil 350d is formed on a corner portion of the vertical deflection coil 300 and disposed adjacent to the non-effective bent portion 330 of the bent coil portion 320 more than the first, second, and third deflection coils 350a, 350b, 350c.

The non-effective bent portion 330 of the bent coil portion 320 forms an angle θ between 15 and 45 degrees with the fourth deflection coil 350d as shown in FIG. 14. The non-effective bent portion 330 of the bent coil portion 320 is different from the conventional deflection yoke in shape and shrinks in size from a dotted line representing a conventional non-effective bent portion toward the inside of the vertical deflection coil 350d.

The fourth deflection coil 350d may be also different from the conventional deflection yoke in shape and moved from a dotted line representing a conventional fourth deflection coil toward the non-effective bent portion 330 of the bent coil portion 320 as shown in a dotted circle of FIG. 14.

The fourth deflection coil 350d becomes closer to the bent coil portion 320 than the conventional deflection yoke by forming the angle θ. between the non-effective bent portion 330 and the fourth deflection coil 350d.

According to another aspect of the present invention, a conventional vertical deflection coil may be extended in a vertical direction downward and upward to form the vertical deflection coil 300 having the non-effective bent portion 330 forming the angle θ with the fourth deflection coil 350d. In this case, a shape of the extended vertical deflection coil 300 becomes an ellipse having a longitudinal center line in the vertical direction, and a ratio between a vertical radius VR corresponding to a Y axis and a horizontal radius HR corresponding to an X axis becomes 1:0.5-0.8 as shown in FIG. 14.

When the ratio between the vertical radius VR corresponding to the Y axis and the horizontal radius HR corresponding to the X axis becomes 1:0.5-0.8, the angle θ between the non-effective bent portion 330 and the fourth deflection coil 350d ranges from 15 through 45 degrees.

The vertical radius VR of the vertical deflection coil 300 is less than a ferrite horizontal radius of the ferrite core 40 surrounding an outside of the vertical deflection coil 300.

A current I flows from a left or right upper portion of the vertical deflection coil 300 to a left or right lower portion of the vertical deflection coil 300 through the bent coil portion 320 and the non-effective bent portion 330.

The current I flows in opposite directions in the fourth deflection coil 350d and the bent coil portion 320 in the front view of the vertical deflection coil 300 of FIG. 14. According to the Fleming' rule, respective magnetic fields of the fourth deflection coil 350d and the bent coil portion 320 become opposite directions.

Since the angle θ formed between the non-effective bent portion 330 and the fourth deflection coil 350d is between 15 and 45 degrees, a phenomenon in which the magnetic field of the non-effective bent portion 330 is offset by the magnetic field of the fourth deflection coil 350d, occurs in the deflection coil formed according to present invention.

As a result, the magnetic field of the fourth deflection coil 350d become weakened compared to magnetic fields of the first, second, and third deflection coil 350a, 350b, 350c.

Since the magnetic field generated from the non-effective bent portion 330 of the bent coil portion 320, which is offset by the magnetic field of the fourth deflection coil 350d, is the unnecessary magnetic field, an deflection operation of the electron beam is not affected in the deflection magnetic field VB even if the unnecessary magnetic field of the non-effective bent portion 330 of the bent coil portion 320 is offset by the magnetic field of the fourth deflection coil 350d.

Since this offset effect is maximized when the noneffective bent portion 330 and the fourth deflection coil 350d are moved from respective positions of the conventional vertical deflection coil in the conventional yoke to positions shown in FIG. 14 and are disposed close to a parallel position, the offset effect becomes more effective and maximized when the angle θ becomes smaller than that of the conventional vertical deflection coil.

Since the magnetic field of the fourth deflection coil 350d can be weakened by the magnetic field of the non-effective bent portion 330, it is not necessary to reduce the number of the windings of the fourth deflection coil 350d to weaken the magnetic field of the fourth deflection coil 350d.

As shown in FIG. 15, the vertical deflection magnetic field VB of the deflection yoke 100 having the magnetic field of the fourth deflection coil 350d which is weakened, is represented by a gentle curved-shape.

The vertical deflection magnetic field VB shows side areas and a center area as the gentle curved-shape of a circular arc, compared to a conventional vertical deflection magnetic field having the side areas concave (representing that magnetic fields of the side areas are stronger than other areas). The both side areas of the vertical deflection magnetic field VB are changed from the convention deflection magnetic field by a change L, thereby reducing (weakening) the magnetic field of the side areas of the vertical deflection magnetic field VB.

Since the magnetic field of a corner area of the vertical deflection magnetic field VB is weakened, the electron beam which is longitudinally extended and deflected to a corner of a screen due to a relatively strong magnetic field of the conventional fourth deflection coil of the conventional vertical deflection coil, is not longitudinally deflected to the corner of the screen but shortly deflected to a corresponding desired area of the screen, thereby compensating for a distortion of a pincushion phenomenon of an image displayed on the screen.

Since the electron beam which is longitudinally extended and deflected to a corner of a screen, is shortly deflected to the corresponding area of the screen, the pincushion distortion is corrected by correcting a conventional barrel shape of the vertical deflection magnetic field VB.

The pincushion distortion is compensated when the vertical deflection magnetic field VB becomes a correct barrel shape which is close to a rectangular.

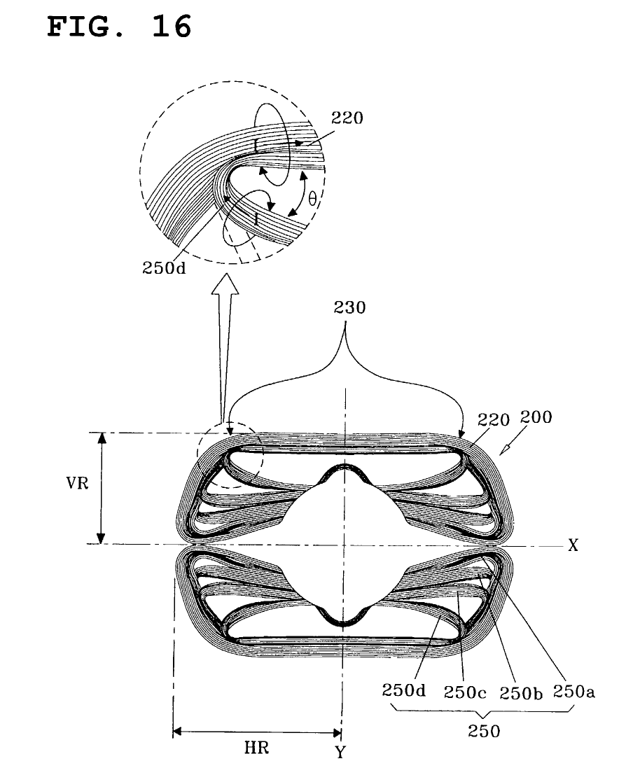

As shown in FIGS. 16 and 17, the horizontal deflection coil 200 may be formed to be the same structure as the vertical deflection coil 300. FIG. 16 is a front view of the horizontal deflection coil 200 shown in FIG. 12, and FIG. 17 is another diagram showing a relationship between the horizontal deflection magnetic field HB and the electron beam in the horizontal deflection coil 200 shown in FIG. 16.

The horizontal deflection coil 200 is formed to be similar to the vertical deflection coil 300 except that the horizontal deflection coil 200 is extended in a horizontal direction while the vertical deflection coil 300 is extended in the vertical direction.

The horizontal deflection coil 200 includes a bent coil portion 220 disposed adjacent to the screen plate 11 of the CRT 100 and having a non-effective bent portion 230 like as the vertical deflection coil 200, a deflection coil portion, and first, second, third, and fourth deflection coils 250a, 250b, 250c, 250d extended from the bent coil portion 220.

The fourth deflection coil 250d is disposed to be substantially parallel to the non-effective bent portion 230 of the bent coil portion 220 to form a horizontal angle θ between 15 and 45 degrees with the non-effective bent portion 230 of the bent coil portion 220.

In order to form the horizontal angle θ between the fourth deflection coil 250d and the non-effective bent portion 230 of the bent coil portion 220, the non-effective bent portion 230 of the bent coil portion 220 is different from the conventional deflection yoke in shape and shrinks in size from a conventional non-effective bent portion of the conventional horizontal deflection coil. The bent coil portion 220 shrinks in the vertical direction and is extended in the horizontal direction (left and right direction).

When a ratio between a horizontal radius HR corresponding to an X axis and a vertical radius VR corresponding to a Y axis becomes 1:0.5-0.8, the angle θ between the non-effective bent portion 230 and the fourth deflection coil 250d ranges from 15 through 45 degrees.

A current I flows through the fourth deflection coil 250d and the non-effective bent portion 230 in opposite directions as shown in a circular in FIG. 16, and opposite magnetic fields are generated. The magnetic field of the non-effective bent portion 230 of the bent coil portion 220 of the horizontal deflection coil 200 is offset by the magnetic field fourth deflection coil 250d like as the vertical deflection coil 300.

When the magnetic field generated from the fourth deflection coil 250d is weakened, the horizontal deflection magnetic field HB is changed (adjusted) by a change L′ from a conventional horizontal deflection magnetic field of a conventional horizontal deflection coil as shown in FIG. 17. That is, upper and lower areas of the horizontal deflection magnetic field HB is weakened more than a center area of the horizontal deflection magnetic field HB compared to the conventional horizontal deflection magnetic field of the conventional horizontal deflection coil.

The center area of the horizontal deflection magnetic field HB becomes close to the R, G, B electron beams since R, G, B electron beams are strongly deflected in a center of the screen more than an upper or lower corner of the screen. The R, G, and B electron beams are collectively called as the electron beam.

The horizontal deflection magnetic field HB strongly deflects the electron beam in the horizontal direction in the center of the screen more than the upper and lower corners of the screen to deflect the electron beam toward a leftmost or rightmost area of the screen.

If the electron beam is deflected toward the leftmost or rightmost area of the screen, a conventional pincushion distortion occurring by the conventional defection coil can be compensated and corrected by forming a correct barrel shape representing the horizontal deflection magnetic field HB formed by the horizontal deflection coil 200.

Since the B and R electron beams disposed close to the center area of the horizontal deflection magnetic field HB is under an influence of a strengthened horizontal deflection force, the B and R electron beams are deflected to the leftmost or rightmost area of the screen, thereby forming a spot with the G electron beam even if the screen is a flat surface. As a result, a misconvergence can be corrected.

That is, both the pincushion distortion and the misconvergence can be simultaneously corrected by strengthening a center area of the horizontal deflection magnetic field HB.

The horizontal deflection coil 200 and the vertical deflection soil 300 formed according to the present invention can be used in a deflection yoke having an unbent type of the neck bent portion 240, 340 formed in an outwardly extended flange shape on the rear portion of the CRT.

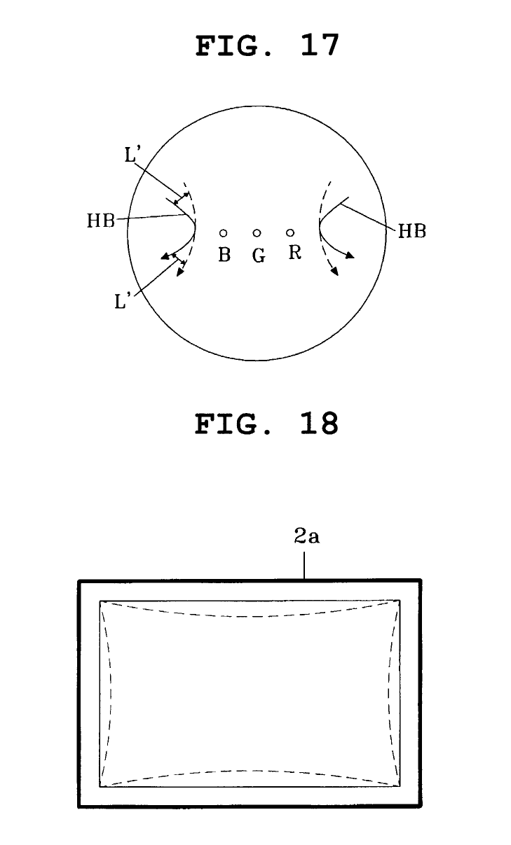

FIG. 18 is another diagram showing a state representing that the pincushion distortion is corrected by the deflection yoke 100. The pincushion distortion and the misconvergence are simultaneously corrected by the deflection yoke 100 having the vertical deflection coil 300 and the horizontal deflection coil 200 formed according to the present invention.

A portion indicated by a dotted line in the screen 2a of the screen plate 11 is the pincushion distortion occurring in the conventional deflection yoke, and another portion indicated by a solid line in the screen 2a of the screen plate 11 is a corrected screen image of the screen 2a of the screen plate 11 which is compensated and corrected by the deflection yoke 100 formed according to the present invention as shown in FIG. 18.

As described above, since the electron beam which is deflected to a corner of the screen in the conventional deflection yoke, is correctly deflected in the deflection yoke 100 shorter than that of the conventional deflection yoke, the magnetic field becomes a corrected barrel shape to correct the pincushion distortion of the screen.

The image screen becomes the rectangular by forming the corrected barrel shape of the magnetic field by the deflection yoke 100.

The horizontal deflection coil 200 and the vertical deflection coil 300 can be formed by using a bobbin type instead of a winding frame type.

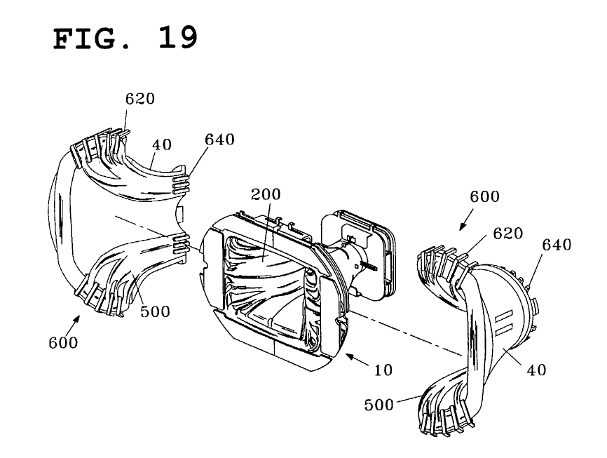

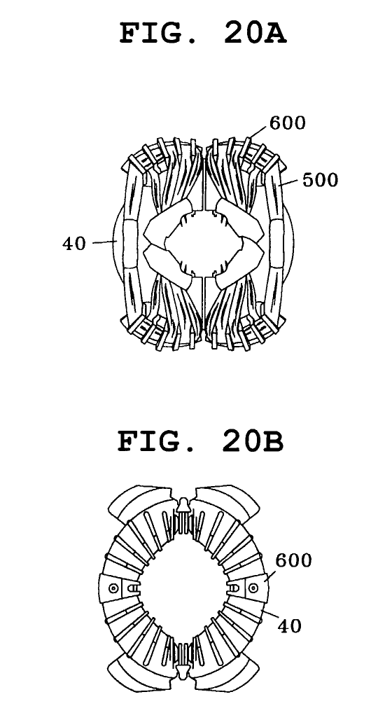

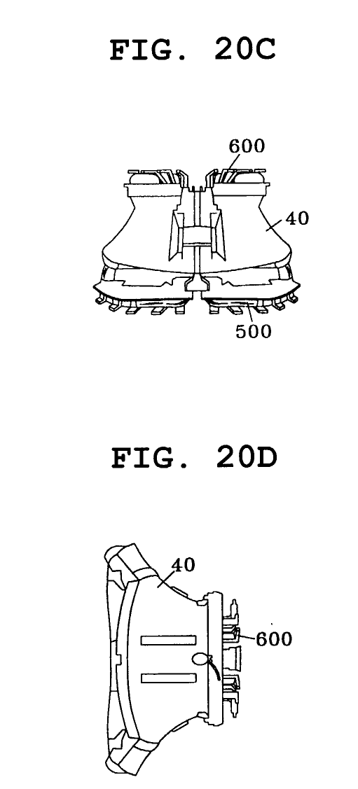

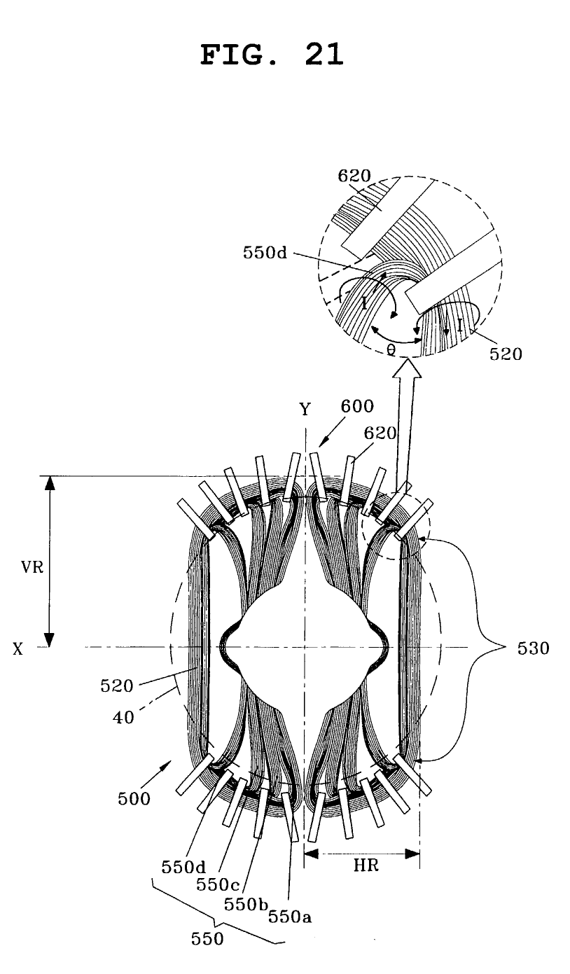

FIGS. 19 through 21 shows a bobbin type deflection coil. FIG. 19 is an exploded view of the bobbin type deflection yoke according to another embodiment of the present invention, FIGS. 20A through 20B show a front view, a rear view, a plain view, and a side view of the deflection yoke shown in FIG. 19, and FIG. 21 is a view showing a front structure of a vertical deflection coil of the deflection yoke shown in FIG. 19.

The deflection yoke 100 includes the coil separator 10 having the horizontal deflection coil 200 formed on the inside of the coil separator 10, a vertical deflection coil 500, and the ferrite core 40 disposed to surround a portion of the vertical deflection coil 500.

The vertical deflection coil 500 is formed by winding a coil around a bobbin 600 having a plurality of front fingers 620 and a plurality of rear fingers 640 disposed adjacent to the screen and the electron gun of the CRT, respectively.

Since the coil of the vertical deflection coil 500 is wound around the front fingers 620 and the rear fingers 640 disposed a front portion and a rear portion of the bobbin 600, respectively, the vertical deflection coil 500 is formed between the rear portion and the rear portion of the bobbin 600.

As shown in FIG. 21, on the front portion of the vertical deflection coil 500 is provided a bent coil portion 520 having a non-effective bent portion 530 generating an unnecessary magnetic field, which is unnecessary to deflect the electron beam in the vertical direction. A deflection coil portion 550 is extended from the bent coil portion 520 to generate the vertical deflection magnetic field VB deflecting the electron beam in the vertical direction.

The deflection coil portion 550 includes first, second, third, and fourth deflection coils 550a, 550b, 550c, 550d in the horizontal direction from the center portion to the side portions of the vertical deflection coil 500. The coil of the vertical deflection coil 500 is would around respective fingers 620 to form the first, second, third, and fourth deflection coils 550a, 550b, 550c, 550d.

One of the front fingers 620 is disposed adjacent to the non-effective bent portion 530 of the bent coil portion 520, and the fourth deflection coil 550d is wound around the one of the front fingers 620 to form the angle θ between 15 and 45 degrees with the bent coil portion 520.

When the ratio between the vertical radius VR and the horizontal radius HR of the vertical deflection coil 500 becomes 1:0.5-0.8, the angle θ between the non-effective bent portion 530 and the fourth deflection coil 550d ranges from 15 through 45 degrees.

The vertical radius VR of the vertical deflection coil 500 is less than the ferrite horizontal radius of the ferrite core 40 surrounding an outside of the vertical deflection coil 500.

A current I flows from a left or right upper portion of the vertical deflection coil 500 to a left or right lower portion of the vertical deflection coil 500 through the bent coil portion 520 and the non-effective bent portion 530. The current I flows in opposite directions in the fourth deflection coil 550d and the bent coil portion 520 to generate opposite magnetic fields, and the magnetic field of the non-effective bent portion 530 is offset by the magnetic field of the fourth deflection coil 550d.

The corner area of the vertical deflection magnetic field VB is weakened since the opposite magnetic field generated from the non-effective bent portion 530 is offset by the magnetic field of the fourth deflection coil 550d. The electron beam is not longitudinally extended to the corner of the screen, thereby preventing the pincushion distortion.

An operation of the vertical deflection magnetic field VB in the deflection yoke to correct the pincushion distortion is the same as the deflection yoke 100 shown in FIGS. 11-18, and a description of the operation of the vertical deflection magnetic field VB is omitted.

The horizontal deflection coil 200 may be formed in the same structure as the vertical deflection coil 500, and the pincushion distortion and the misconvergence are simultaneously corrected when the horizontal deflection coil 200 is formed in the same structure as the vertical deflection coil 500.

As described above, the deflection yoke 100 can correct the pincushion distortion as well as the misconvergence without adjusting the number of the windings (turn ratio) of the deflection coil portion of the horizontal and vertical deflection coils 200, 300, 500.

Since additional permanent magnets or magnetic materials are not needed to correct the pincushion distortion, the number of parts and a manufacturing cost can be reduced.

Since the electron beam which is deflected to the corner of the screen in the conventional deflection yoke, is correctly deflected to the corresponding desired area of the screen in the deflection yoke compared to the conventional deflection yoke, the magnetic field becomes the corrected barrel shape to correct the pincushion distortion of the screen as well as the misconvergence.

Although a few preferred embodiments of the present invention have been shown and described, it would be appreciated by those skilled in the art that changes may be made in this embodiment without departing from the principle and sprit of the invention, the scope of which is defined in the claims and their equivalent.

What is claimed is:

1. A deflection yoke attached to a cathode ray tube to deflect an electron beam generated from an electron gun to an s area of a screen, comprises:
a coil separator having a horn shape;
a horizontal deflection coil having a pair of first coils disposed on an inside of the coil separator to generate a horizontal deflection magnetic field to deflect the electron beam in a horizontal direction;
a vertical deflection coil having a pair of second coils disposed on an outside of the coil separator to generate a vertical deflection magnetic field to deflect the electron beam in a vertical direction, each second coil having deflection coil portions, bent coil portions extended from respective ones of the deflection coil portions toward the screen, and a non-effective bet portion disposed between the bent coil portions to generate a magnetic field, which is in a direction opposite to another magnetic field generated from a corresponding portion of the deflection coil portion disposed adjacent to the non-effective bent portion of the bent coil portion and weakens another magnetic field generated from the corresponding portion of the deflection coil portions, and each second coil having a vertical radius and a horizontal radius, which is different from the vertical radius; and
a ferrite core having a cylindrical shape covering a portion of the deflection coil portions of the vertical deflection coil to strengthen the vertical deflection magnetic field and the horizontal deflection magnetic field.

2. The deflection yoke of claim 1, wherein the vertical radius and the horizontal radius of the vertical deflection coil have a ratio of 1:0.5-0.8.

3. The deflection yoke of claim 1, wherein the non-effective bent portion of the bent coil portion disposed adjacent to the screen and the corresponding portion of the deflection coil portions form an angle in a range between 15 and 45 degrees inclusive.

4. The deflection yoke of claim 1, further comprising:
a bobbin attached to the outside of the coil separator, wherein the vertical deflection coil is formed on the bobbin.

5. The deflection yoke of claim 1, wherein the horizontal radius of the vertical deflection coil is less than that of the ferrite core.

6. A deflection yoke attached to a cathode ray tube to deflect an electron beam generated from an electron gun to an area of a screen, comprises:
a coil separator having a horn shape;
a horizontal deflection coil having a pair of first coils disposed on an inside of the coil separator to generate a horizontal deflection magnetic field to deflect the electron beam in a horizontal direction, each first coil having deflection coil portions, bent coil portions extended from respective ones of the deflection coil portion toward the screen, and a non-effective bent portion disposed between the bent coil portions to generate a magnetic field, which is in a direction to opposite to another magnetic field generated from a corresponding portion of the deflection coil portions disposed adjacent to the non-effective bent portion of the bent coil portion and weakens another magnetic field generated from the corresponding portion of the deflection coil portion, and having a vertical radius and a horizontal radius, which is different from the vertical radius;
a vertical deflection coil having a pair of second coils disposed on an outside of the coil separator to generate a vertical deflection magnetic field to deflect the electron beam in a vertical direction; and
a ferrite core having a cylindrical shape covering a portion of the deflection coil portions of the vertical deflection coil to strengthen the vertical deflection magnetic field and the horizontal deflection magnetic field.

7. The deflection yoke of claim 6, wherein the vertical radius and the horizontal radius of the horizontal deflection coil have a ratio of 1:0.5-0.8.

8. The deflection yoke of claim 6, wherein the non-effective bent portion of the bent coil portion disposed adjacent to the screen and the corresponding portion of the deflection coil portion form an angle in a range between 15 and 45 degrees inclusive.

9. The deflection yoke of claim 6, further comprising:
a bobbin attached to the outside of the coil separator, wherein the vertical deflection coil is formed on the bobbin.

10. A deflection yoke attached to a cathode ray tube to deflect an electron beam generated from an electron gun to an area of a screen, comprises:
a coil separator;
a horizontal deflection coil having a pair of first coils disposed on an inside of the coil separator to generate a horizontal deflection magnetic field to deflect the electron beam in a horizontal direction, and having a first vertical radius and a first horizontal radius which is greater than the first vertical radius; a
vertical deflection coil having a pair of second coils disposed on an outside of the coil separator to generate a vertical deflection magnetic field to deflect the electron beam in a vertical direction, and having a second vertical radius and a second horizontal radius which is smaller than the second vertical radius; and
a ferrite core having a cylindrical shape covering a portion of the vertical deflection coil to strengthen the vertical deflection magnetic field and the horizontal deflection magnetic field.

11. The deflection yoke of claim 10, wherein each first coil of the horizontal deflection coil comprises:
deflection coil portions spaced-apart from each other to generate the horizontal deflection magnetic field;
a bent coil portion extended from the deflection coil portions; and
a non-effective bent portion formed in the bent coil portion and between the deflection coil portions, and forming the first vertical radius with a center line disposed between the first coils of the horizontal deflection coil.

12. The deflection yoke of claim 11, wherein the noneffective bent portion comprises:
a non-curve portion longer than the first vertical radius.

13. The deflection yoke of claim 12, wherein the non-curve portion is parallel to the center line.

14. The deflection yoke of claim 11, wherein the bent coil portion forms the first horizontal radius with a center line of the first coil.

15. The deflection yoke of claim 11, wherein each deflection coil portion comprises a plurality of deflection coils, one of the deflection coils generates a magnetic field, and the non-effective bent portion generates another magnetic field offset by the magnetic field of the one of the deflection coils.

16. The deflection yoke of claim 15, wherein the magnetic field of the one of the deflection coils is formed in a direction, and another magnetic field of the non-effective bent portion is formed in another direction opposite to the direction.

17. The deflection yoke of claim 15, wherein the magnetic field of the one of the deflection coils is weakened by another magnetic field of the non-effective bent portion.

18. The deflection yoke of claim 15, wherein the one of the deflection coils is disposed closer to the non-effective bent portion than other deflection coils.

19. The deflection yoke of claim 15, wherein the one of the deflection coils and the non-effective bent portion form an angle in a range between 15 and 45 degrees inclusive.

20. The deflection yoke of claim 15, wherein the deflection coils comprises first, second, third, and fourth deflection coils disposed in order in a direction from a center line between the first coils to the non-effective bent portion, and the fourth deflection coil is disposed closer to the non-effective bent portion than the first, second, and third deflection coils.

21. The deflection yoke of claim 20, wherein the fourth deflection coil generates a magnetic field, and the non-effective bent portion generates another magnetic field weakening the magnetic field of the fourth deflection coil.

22. The deflection yoke of claim 20, wherein the fourth deflection coil and the non-effective bent portion form an angle in a range between 15 and 45 degrees inclusive.

23. The deflection yoke of claim 20, wherein a first current flows through the fourth deflection coil in a first direction, and a second current flows through the non-effective bent portion in a second direction opposite to the first direction.

24. The deflection yoke of claim 10, wherein the first horizontal radius and the first vertical radius have a ratio of 1:0.5-0.8.

25. The deflection yoke of claim 10, wherein each second coil of the vertical deflection coil comprises:
deflection coil portions spaced-apart from each other to generate the vertical deflection magnetic field;
a bent coil portion extended from the deflection coil portions; and
a non-effective bent portion formed in the bent coil portion and between the deflection coil portions, and forming the second vertical radius with a center line disposed between the second coils of the vertical deflection coil.

26. The deflection yoke of claim 25, wherein the non-effective bent portion comprises:
a non-curve portion longer than the -second horizontal radius.

27. The deflection yoke of claim 26, wherein the non-curve portion is parallel to the center line.

28. The deflection yoke of claim 25, wherein the bent coil portion forms the second horizontal radius with a center line of the second coil.

29. The deflection yoke of claim 25, wherein each deflection coil portion comprises a plurality of deflection coils, one of the deflection coils generates a magnetic field, and the non-effective bent portion generates another magnetic field offset by the magnetic field of the one of the deflection coils.

30. The deflection yoke of claim 29, wherein the magnetic field of the one of the deflection coils is formed in a direction, and another magnetic field of the non-effective bent portion is formed in another direction opposite to the direction.

31. The deflection yoke of claim 29, wherein the magnetic field of the one of the deflection coils is weakened by another magnetic field of the non-effective bent portion.

32. The deflection yoke of claim 29, wherein the one of the deflection coils is disposed closer to the non-effective bent portion than other deflection coils.

33. The deflection yoke of claim 29, wherein the one of the deflection coils and the non-effective bent portion form an angle in a range between 15 and 45 degrees inclusive.

34. The deflection yoke of claim 29, wherein the deflection coils comprises first, second, third, and fourth deflection coils disposed in order in a direction from a center line formed between the second coils to the non-effective bent portion, and the fourth deflection coil is disposed closer to the non-effective bent portion than the first, second, and third deflection coils.

35. The deflection yoke of claim 34, wherein the fourth deflection coil generates a magnetic field, and the non-effective bent portion generates another magnetic field weakening the magnetic field of the fourth deflection coil.

36. The deflection yoke of claim 34, wherein the fourth deflection coil and the non-effective bent portion form an angle in a range between 15 and 45 degrees inclusive.

37. The deflection yoke of claim 34, wherein a first current flows through the fourth deflection coil in a first direction, and a second current flows through the non-effective bent portion in a second direction opposite to the first direction.

38. The deflection yoke of claim 10, wherein the second vertical radius and the second horizontal radius have a ratio of 1:0.5-0.8.

39. The deflection yoke of claim 10, wherein the second horizontal radius is less than a ferrite radius of the ferrite core.

40. The deflection yoke of claim 10, further comprising:
a bobbin attached to the outside of the coil separator, wherein the vertical deflection coil is formed on the bobbin.

41. The deflection yoke of claim 39, wherein the bobbin comprises:
a pair of half portions, wherein each second coil attached to the outside of corresponding ones of the half portions.

42. The deflection yoke of claim 39, wherein each half portion of the bobbin comprises a plurality of fingers, and each second coil of the vertical deflection coil comprises:
deflection coil portions each having a plurality of deflection coils each winding around the corresponding fingers to generate the vertical deflection magnetic field;
a bent coil portion extended from the deflection coil portions; and
a non-effective bent portion formed in the bent coil portion and between the deflection coil portions, and forming the second vertical radius with a center line disposed between the second coils of the vertical deflection coil.

43. The deflection yoke of claim 42, wherein one of the deflection coils generates a magnetic field, and the non-effective bent portion generates another magnetic field offset by the magnetic field of the one of the deflection coils.

44. The deflection yoke of claim 43, wherein the magnetic field of the one of the deflection coils is formed in a direction, and another magnetic field of the non-effective bent portion is formed in another direction opposite to the direction.

45. The deflection yoke of claim 43, wherein a first current flows through the one of the deflection coils in a first direction, and a second current flows through the noneffective bent portion in a second direction opposite to the first direction.

46. The deflection yoke of claim 43, wherein the fingers comprises first, second, third, and fourth fingers, and the deflection coils comprises first, second, third, and fourth deflection coils disposed in order in a direction from a center line formed between the second coils to the non-effective bent portion and each having a coil winding around corresponding ones of the first, second, third, and fourth fingers.

47. The deflection yoke of claim 46, wherein the fourth deflection coil is disposed to generate a magnetic field, and the non-effective bent portion is disposed to generate another magnetic field offset by the magnetic field of the fourth deflection coil.

48. The deflection yoke of claim 46, wherein the magnetic field of the fourth deflection coil is weakened by the another magnetic field of the non-effective bent portion so as to correct a pincushion and a misconvergence.
